(19) United States
(12) Patent Application Publication
(10) Pub. No.: US 2020/0386951 A1
(43) Pub. Date: Dec. 10, 2020

(54) DUAL FERRULE OPTICAL CONNECTOR SIGNAL TESTING CONVERTER AND METHOD OF USE

(71) Applicant: Senko Advanced Components, Inc., Marlborough, MA (US)

(72) Inventors: Heng Loong LEE, Puchong (MY); Takuya NINOMIYA, Natick, MA (US); Kim Man WONG, Kowloon (HK); Jimmy CHANG, Worcester, MA (US); Kazuyoshi TAKANO, Tokyo (JP)

(73) Assignee: Senko Advanced Components, Inc., Marlborough, MA (US)

(21) Appl. No.: 16/895,398

(22) Filed: Jun. 8, 2020

Related U.S. Application Data
(60) Provisional application No. 62/857,907, filed on Jun. 6, 2019.

(51) Int. Cl. G02B 6/38; G01M 11/00

(52) U.S. Cl. CPC G02B 6/385; G01M 11/33; G02B 6/3831; G02B 6/3825

(57) ABSTRACT

A converter with an outer housing having a first end and a second end. The first end further comprises a male, simplex fiber optic connector that is received by a test port of an optical signal tester. The second end of the converter has a port configured to accept an optical fiber connector with a first ferrule and a second ferrule with an optical fiber therein spliced to an incoming optical fiber with a signal from a network. The tester confirms the signal strength in dB when optical fiber connector is in test position “A” for the first ferrule and in test position “B” for the second ferrule.

### CROSS-REFERENCE TO RELATED-APPLICATIONS

This application claims the benefit of priority of U.S. Provisional Application No. 62/857,907 filed on Jun. 6, 2019, which is incorporated herein by reference in its entirety.

### BACKGROUND

Demand for bandwidth by enterprises and individual consumers continues to experience exponential growth. To meet this demand efficiently and economically, data centers have to achieve ultra-high density cabling with low loss budgets. Fiber optics have become the standard cabling medium used by data centers to meet the growing needs for data volume and transmission speeds. Before installing the connector, the signal strength in decibels needs to be confirmed. A tester with a simplex fiber optic port can accept a ferrule with at least one optical fiber therein is well-known in the industry. An example tester is sold by Fluke® and others and is depicted in FIG. 1C and FIG. 1D. These testers can range from $500 to $1,000 USD. Existing testers only have a single test port so there is a long-felt need to provide a converter or adapter-converter to allow testing of each individual ferrule with an embedded optical fiber of an optical fiber connector. An example of a first optical fiber connector and corresponding adapter is disclosed in U.S. Pat. No. 10,185,100B2, Takano, Modular Connector and Adapter Assembly Using a Removable Anchor Device, issued Jan. 22, 2019, and which is fully incorporated by reference into this application. A second optical fiber connector is disclosed in U.S. Pat. No. 10,281,668B2, Takano, Ultra-Small Form Factor Connectors, issued on May 7, 2019, and which is fully incorporated by reference into this application. A polarity changeable duplex optical ferrule fiber optic connector with polarity change is disclosed in U.S. Pat. No. 10,191,230B2, Wong, Optical Connectors with Reversible Polarity, issued Jan. 29, 2019, and which is fully incorporated by reference into this application. The above patent applications are owned by the assignee of the present invention. Other industry duplex optical ferrule fiber optic connectors can be tested using the present invention, such as WO2018126333A1, Higley, Mini Duplex Connector with Push-Pull Polarity Mechanism and Carrier, published Jun. 27, 2019. This publication is not owned by the assignee of the present invention. In the Higley application, the connector has two optical ferrules with a latch on the outside of the connector outer housing. The use of this external latch converter embodiment is disclosure below.

Individual optical fibers are extremely small. For example, even with protective coatings, optical fibers may be only about 250 microns in diameter (only about 4 times the diameter of a human hair). As such, hundreds of fibers can be installed in cables that will take up relatively little space. For connections between cables, however, the fibers are terminated with connectors. Multiple fibers may be arranged within a single connector. For example, multi-fiber connectors such as those using LC type connectors may contain and connect two fibers. An optical fiber transmit data by light, and the strength of the light signal measured in decibels (dB) must meet a standard threshold in order for the light signal to travel from a transceiver to a receiver. Along the route, one or more fiber optic connectors and other dividers or multiplexer devices are installed as part of the network. Securing a tester to a ferrule can measure the signal strength at the fiber optic connector, and if below a specific threshold in dB, the installer may need to check the fiber optic connector for damaged or broken fiber, or a failed connector.

Typically, LC type connectors are joined together to connect the optical transmission path of one fiber optic cable to another fiber optic cable or device, and the connection may be made by inserting the LC type connectors in an LC adapter. LC type connectors may be simplex or duplex, or quad depending on the connector outer housing. An adapter generally includes a housing, or portion of a housing, having at least one port which is configured to receive and hold a LC type connector to facilitate the optical connection of a connector ferrule with a ferrule of another connector or other device that opposes the connector in the first adapter port, thereby establishing an optical connection with a similar optical ferrule inserted into a second adapter port, where the first adapter port opposes the second adapter port. Adapters may be used to facilitate connections contained within a chassis. The term “chassis” as used herein broadly refers to a containment structure for housing electrical components or switching components.

Another test is signal strength for connector having polarity. Polarity is determined during manufacturing of the connector and associated cable. For installations where the polarity may need to be changed for one reason or another, such as a renovation or installation of a new optical component, the polarity of typical connectors is not changeable or only changeable after disassembly and reassembly in the opposite designation. For example, some LC type connectors include a modular housing configured such that the position of the fibers terminated within the connector can be reversed, thus changing the polarity of the connector. However, this can be a time-sensitive procedure and, based upon the abilities of the person changing the connector, may be prone to error.

So therefore, there remains a need to use existing testing equipment for duplex LC-type fiber optic connectors. Industry connector models are expanding so there is a further need to test various models of duplex fiber optic connectors that are configured with two LC type optical ferrules, with a first ferrule designated top transmit (Tx) and a second ferrule designated to receiver (Rx). So when a duplex fiber optic connector is inserted into the first port, it must be inserted with the polarity correctly opposing the second opposing duplex fiber optic connector, but only after the Tx and Rx signal delivered and received by at least optical fiber embedded in the ferrule is confirmed as passing the minimum threshold in dB for proper operation.

### SUMMARY

In a first embodiment, a converted has an outer housing similarly constructed as an adapter housing. The converter housing has a first end and a second end that forms a longitudinal channel therebetween. The first end has a LC-type male fiber optic connector configured to be interfaced with a port on test equipment. The test equipment measures signal strength in decibels transmitted by an optical fiber contained within the fiber optic connector. The optical fiber is in communication with an incoming optical fiber from a fiber optic cable. The fiber optic cable is terminated at a second end within a fiber optic communications network or connected to transceiver that delivers an optical signal. The second end of the converter outer housing is open with an internal adapter inserted or formed within the converter housing. The adapter hook is formed to accept and secure an optical fiber connector. A pair of opposing latch arms may form the adapter hook and accept a first optical fiber connector as disclosed in U.S. Pat. No. 10,281,668B2, Takano, which is fully incorporated by reference. The adapter hook may be an anchor device to accept a second optical fiber connector as disclosed in U.S. Pat. No. 10,185,100B2, to Takano, which is fully incorporated by reference. Alternatively, no adapter hook may be formed or secured within the second end to form one or more ports. One or more openings or recesses formed within outer housing wall may accept a third optical fiber connector with a latch formed on the outside of the optical fiber connector.

As disclosed, the optical fiber connector is a fiber optic connector with at least two optical ferrules. Each ferrule has at least one optical fiber therein, and the optical fiber is spliced to an incoming optical fiber provided by a fiber optic cable. The optical fiber connector further comprises an inner body, backbody, outer housing, pull tab or cable boot release, ferrule flange may hold the ferrule and a bias spring.

In operation, the converter is configured to accept the optical fiber connector, and is inserted in a first test position “A”. The first end is attached to the test port of the tester. And the user operates the test equipment to measure optical signal strength in decibels. The user then (i) rotates the optical fiber connector one-hundred and eighty (180) degrees or (ii) removes the optical fiber connector and reinserts the connector into a second port to performed test “B”. Test “A” is measuring signal strength of a first optical fiber and test “B” is measuring signal strength of a second optical fiber. Each optical fiber connector has at least two optical fibers. There could a third test “C” without departing from the scope of the invention.

In another embodiment, the first end male LC-type optical connector may be secured within a female simplex adapter or the first end of the converter may be formed of a female simplex adapter. This depends on what type of external network configuration the converter is connected with. At the second end of the converter three ports are formed with two inactive ports and a middle active port. The middle port is in optical communication with a first optical fiber ferrule or a second optical fiber ferrule for determining signal strength as described herein. The inactive port holds the second optical fiber ferrule during testing. The inactive port is sometimes called the dummy port.

### BRIEF DESCRIPTION OF THE FIGURES

FIG. 1A a first duplex optical ferrule fiber optic connector assembled with a converter as disclosed in the present invention;

FIG. 1B is a perspective view of the converted as disclosed in the present invention;

FIG. 1C is a prior art optical signal strength tester with a call-out of the single test port;

FIG. 1D is a front view of the tester;

FIG. 1E are a plurality of fixtures to test ferrule endfaces such as APC, UPC or standard with the tester;

FIG. 2A is a perspective view of a second duplex optical ferrule fiber optic connector assembled with the converter in a first test position “A” according to another embodiment of the present invention;

FIG. 2B is a perspective view of another embodiment of the converter;

FIG. 2C is a perspective view of the second duplex optical ferrule fiber optic connector assembled with the converter in a second test position “B”;

FIG. 3A is a perspective view of the converter second end without a duplex optical ferrule fiber optic connector configured in test position “A”;

FIG. 3B is a perspective view of the converter second end without a duplex optical ferrule fiber optic connector configured in test position “B”;

FIG. 4 is a perspective view of the converter assembled with the first duplex optical ferrule fiber optic connector in a first test position “A”;

FIG. 5A is a cross-section of FIG. 4 in the first test position “A”,

FIG. 5B is a cross-section of the first duplex optical ferrule fiber optic connector in the second test position “B”;

FIG. 6A is an end view rotating a first optical fiber one-hundred and eighty degrees from a first test position “A” to a second test position “B” using the converter according to an embodiment of the present invention;

FIG. 6B is an end view of FIG. 6A as the first optical fiber is being rotated;

FIG. 6C is an end view of FIG. 6A rotated to ninety (90) degrees;

FIG. 6D is an end view of FIG. 6A being rotated into the second test position “B”;

FIG. 7A is an exploded view of the converter accepting an anchor device according to another embodiment of the present invention;

FIG. 7B is a view of the second end of FIG. 7A assembled;

FIG. 8A is a perspective view of another embodiment of the converted configured with a female simplex adapter at the first end;

FIG. 8B is a perspective view of the second end of FIG. 8A;

FIG. 9 is an exploded view of converter with a male LC-type optical connector port at the first end accepting a female simplex adapter and a dual optical ferrule fiber optic connector being inserted into the converter at a second end;

FIG. 10 is an assembled view of the converted with the second duplex optical ferrule fiber optic connector in test position “B”;

FIG. 11A is a cut-away view of the second duplex optical ferrule fiber optic connector secured within the second end of the converter in test position “B”;

FIG. 11B is a cut-away view of the second duplex optical ferrule fiber optic connector secured within the second end of the converter in test position “A”;

FIG. 12 is an assembled view of the second duplex optical ferrule fiber optic connector secured within the converter;

FIG. 13 is a cross-section view along line A-A of FIG. 12 in test position “A”, and

FIG. 14 is a cross-section view along line A-A of FIG. 12 in test position “B”.

Corresponding reference numbers indicate corresponding part numbers throughout the drawings;

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A connector, as used herein, refers to a device and/or component thereof that connects a first module or cable to a second module or cable. The connector may be configured for fiber optic transmission or electrical signal transmission. The connector may be any suitable type now known or later developed, such as, for example, a ferrule connector (FC), a fiber distributed data interface (FDDI) connector, an LC connector, a mechanical transfer (MT) connector, a square connector (SC) connector, an SC duplex connector, or a straight tip (ST) connector. The connector may generally be defined by a connector housing body. In some embodiments, the housing body may incorporate any or all of the components described herein.

A “fiber optic cable” or an “optical cable” refers to a cable containing one or more optical fibers for conducting optical signals in beams of light. The optical fibers can be constructed from any suitable transparent material, including glass, fiberglass, and plastic. The cable can include a jacket or sheathing material surrounding the optical fibers. In addition, the cable can be connected to a connector on one end or on both ends of the cable.

Various parts, components or configurations described with respect to any one embodiment above may also be adapted to any others of the embodiments provided.

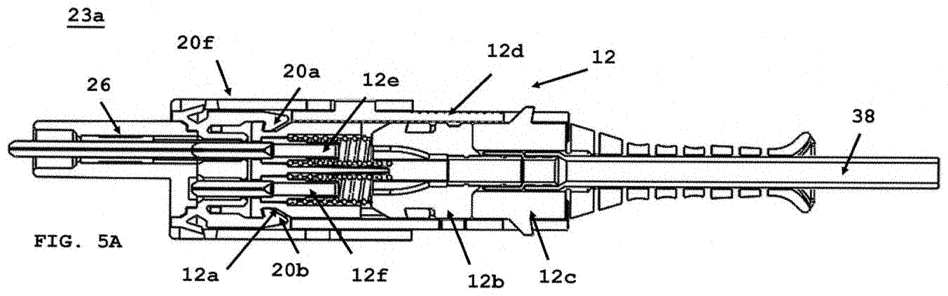

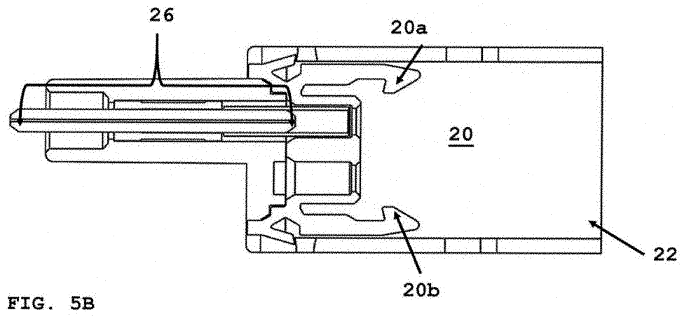

Referring to FIG. 5A and FIG. 8, in the present invention, an optical fiber connector further comprises an outer housing with a recess (12a), inner body, backbody, crimp ring, and two ferrule assemblies. Each ferrule assembly further comprises a bias spring, a ferrule flange with a ferrule disposed opposite the bias spring, and at least one optical fiber embedded within the ferrule. The optical fiber is spliced or connected to an incoming, corresponding optical fiber from an optical cable connected to a network. Typically optical fiber connectors deployed in this invention are disclosed in Takano U.S. Pat. No. 10,185,100B2, Takano U.S. Pat. No. 10,281,668B2 or Higley WO2018126333A1. The tester is determining the signal strength from the incoming signal from the network as it passes through the fiber optic connector. Any signal loss below a recommended signal strength in dB indicates the fiber optic connector may be damaged, or the optical fiber may be damaged. Also testing the first ferrule and the second ferrule indicates the transmit (Tx) and receive (Rx) signal strengths are acceptable.

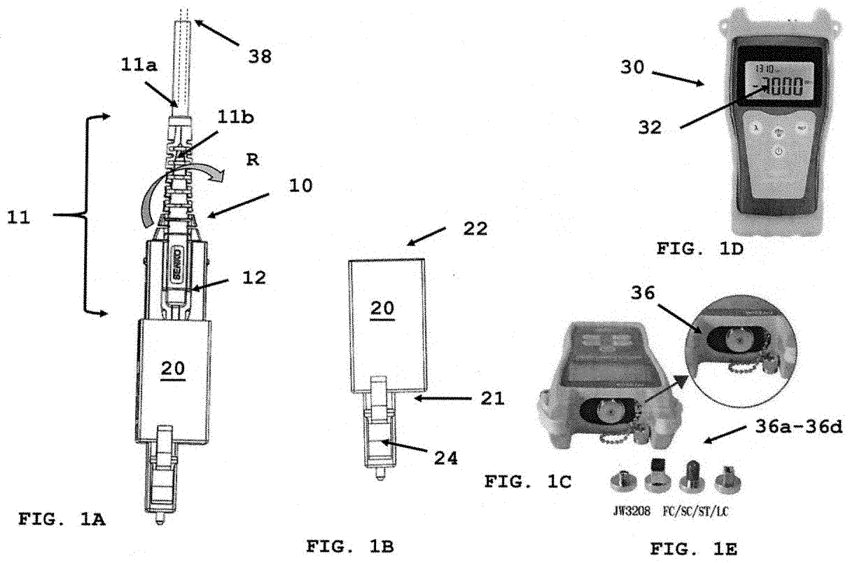

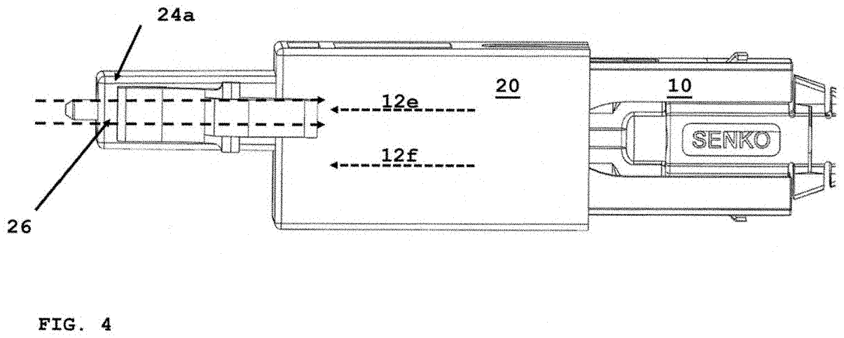

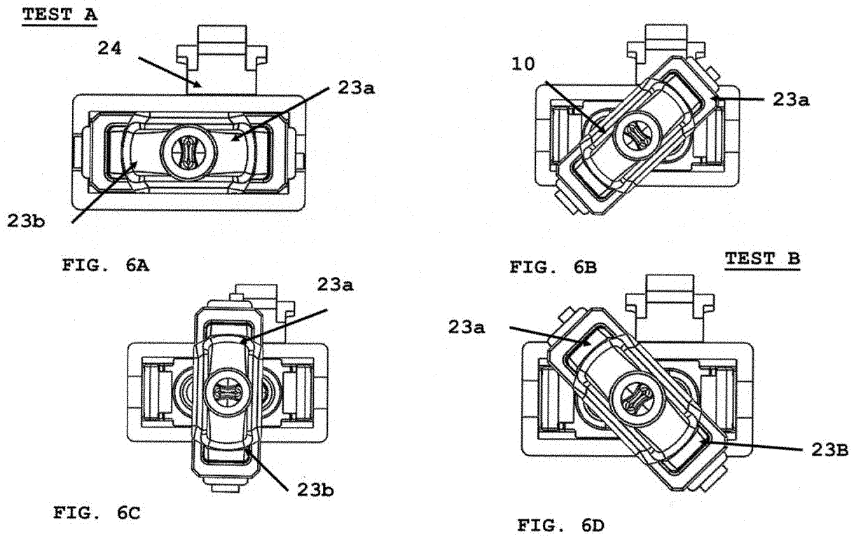

FIG. 1A depicts a first optical fiber connector (10) further comprising connector body (12) with recess (12a), cable boot assembly (11) comprising incoming fiber optic cable (11a) with one or more optical fibers (38) transmitting an optical signal. First optical fiber connector (10) is secured within converter (20). To change from a first test position “A” (23a) to a second test position “B” (23b), the user rotates in direction of “R”, as discussed further in FIGS. 6A-6D. FIG. 1B depicts converter (20) further comprising a first end (21) including a male simplex LC-type fiber optic connector (24) and second end (22). The second end is open configured with an internal adapter hook that forms one or more ports configured to accept one or more data center connectors, as described below. FIG. 1C through FIG. 1D depicts a prior art tester for measuring signal strength in decibels. FIG. 1C is view of test port (36) that is in optical communication with the LC-type connector (24) and this is in optical communication, refer to FIG. 4, via extended ferrule (26) in optical communication with first optical fiber ferrule (12e) when measuring signal strength in first test position “A”, and then the optical fiber connector is installed at the second end (22) in second test position “B” to measure signal strength of second ferrule (12f). FIG. 1D depicts a view of tester (30) keypad and display (32) showing the optical strength, in decibels (dB), as measured. FIG. 1E depicts a number of fixtures attached to test port (36) to accept one or more ferrule endface cuts (36a-36d), such as an angled cut or uniform cut.

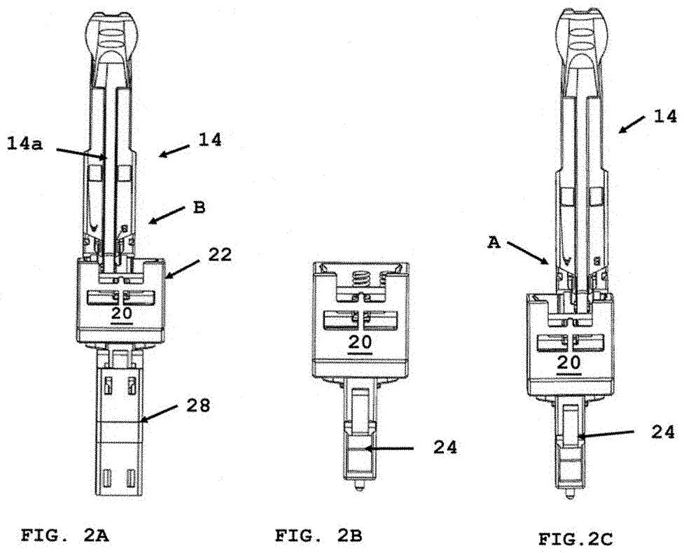

FIG. 2A depicts a second optical fiber connector (14), disclosed in U.S. Pat. No. 10,185,100, is inserted at second end (22) of converter (20). A female simplex adapter (28) is secured at proximal end of simplex, male LC-type optical connector (24) (refer to FIG. 2B depicts connector (24)). In FIG. 2A, the optical fiber connector (14) is in a first test position “A” (23a). In FIG. 2C, connector (14) is in a second test position “B” (23b), with a LC-type optical connector (24) at first end (21). The second test position measures a signal strength of a first ferrule formed as part of the optical fiber connector and the first test position measures a signal strength of a second ferrule formed as part of the optical fiber connector.

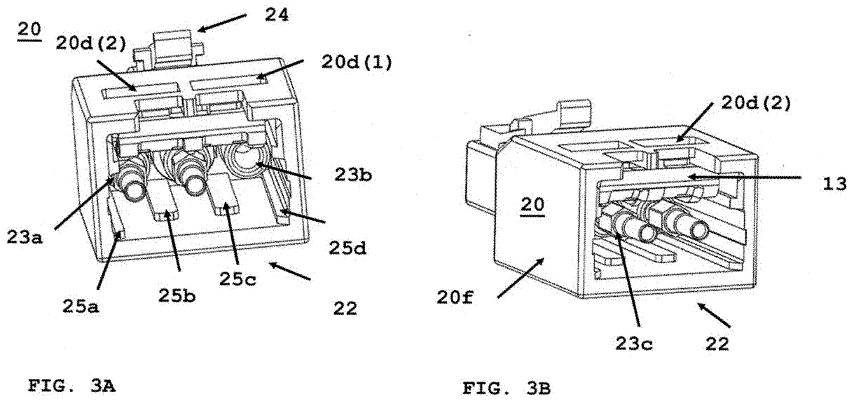

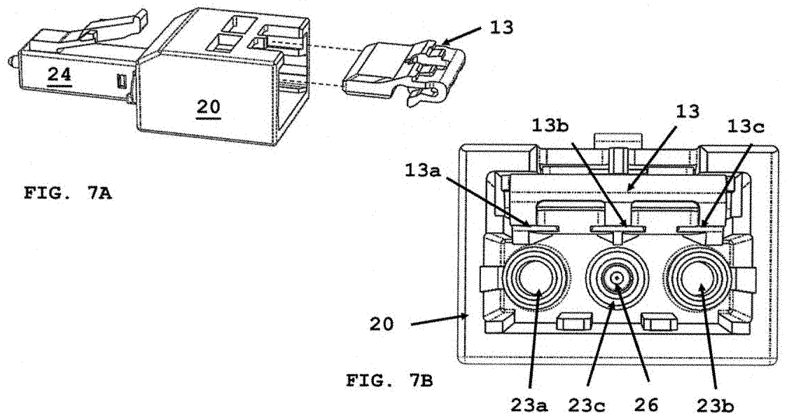

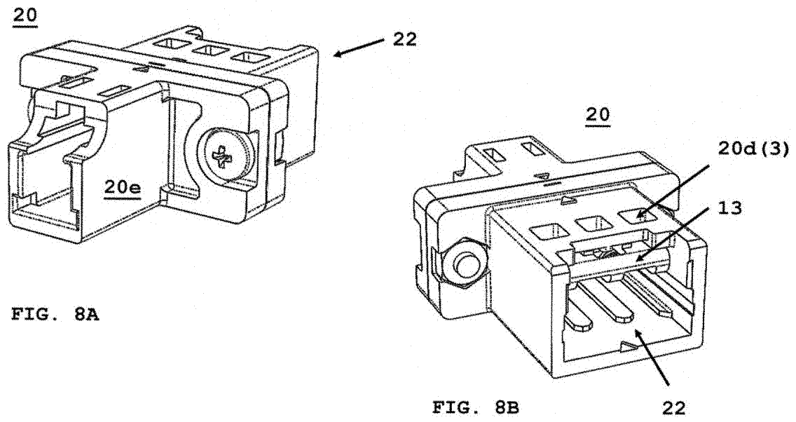

FIG. 3A depicts second end (22) without the optical fiber connector (14) installed, but depicting the connector in a first test position “A”. The converter outer housing (20f) includes one or more openings (20d(1)-20d(3)) through the outer housing that can accept a third optical fiber connector with an external latch on the connector outer housing. Connector (14) is secured within second end (22) and secured by anchor device (13) by latches (13a-13c) (refer to FIG. 7B) depending on the test position “A” or test position “B”. To align the connector within the second end, rails (25a-25d) provide support so the connector does not get jammed upon insertion. FIG. 3A depicts first test position “A” (23a) when the optical fiber connector is secured within ports (23a, 23c). FIG. 3B depicts second test position “B” (23b) with optical fiber connector (14) (not shown) installed in ports (23c, 23b). Without departing from the scope of the invention, test position “A” may be defined by ports (23a, 23c). The signal test port (23c) is the active port for the selected ferrule (12e, 12f) being measure for signal strength via the test equipment of FIG. 1C.

FIG. 4 depicts a side view of optical fiber connector (10) secured at second end (22) of converter (20). The optical fiber ferrules (12e, 12f) are tested by each ferrule being placed in optical communication with an extended ferrule (26) formed as part of the simplex, male LC-type optical connector (24) stored within the plug frame (24a) of connector (24).

FIG. 5A is a cross-section view of connector (10) within converter (20) configured in test position “A” (23a). As illustrated extended ferrule (26) is in optical communication with first ferrule (12e). Connector (10) is secured within the second end (22) by opposing latch hooks (20a, 20b) positioned with recess (12a). Further illustrated is backbody (12c), inner body (12b), first ferrule (12e) and second ferrule (12f), connector outer housing (12d) and incoming optical cable with optical fibers (38). The second optical fiber connector (14) has a similar structure as the first optical fiber connector (10). FIG. 5B is a cross-section of converter (20), without an optical fiber connector installed. Opposing latch hooks (20a, 20b) would secure optical fiber connector (10) within second end (22). First end (21) further comprises LC-type optical connector with extended ferrule (26).

FIG. 6A depicts connector (10) in a first test position “A” (23a). FIG. 6B through FIG. 6D depicts rotating connector (10) into second test position “B”. After rotating one-hundred and eighty (180) degrees, connector (10) is in test position “B” (23b). FIG. 7A depicts an exploded view of converter (20) being configured to accept anchor device (13), with simplex, male LC-type fiber optic connector (24) at a first end. FIG. 7B depicts an end view of the second end (22) without an optical fiber connector installed. Anchor device (13) has a set of latches (13a, 13b) for configuring connector (14) in first test position “A” (23a, 23c), with the active port or testing pathway (23c). Removing and inserting connector (14) in second test position “B” (23b) secures the connector via latches (13b, 13c).

FIG. 8A depicts simplex, female adapter (20e) replacing the simplex male connector (24) at the first end of the converter (20), with the second end receiving an optical fiber connector. FIG. 8B depicts the second end of FIG. 8A with anchor device (13) to secure the second optical fiber connector (14) as described above in FIG. 3A. The anchor device (13) can be removed and a third optical fiber connector, similar to the fiber optic connector disclosed in Higley, can be inserted and secured by its external latch received in opening (20d(3)).

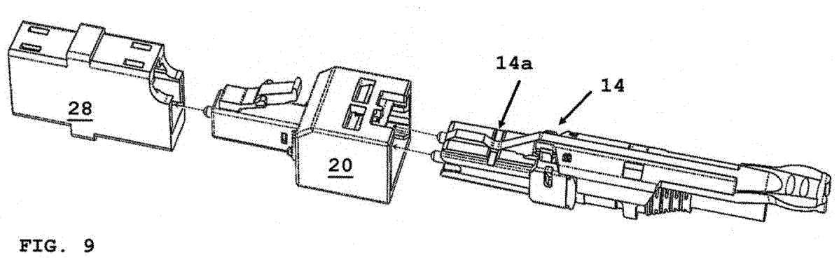

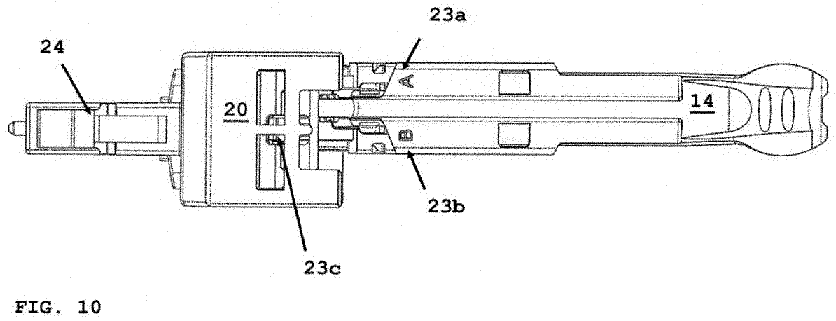

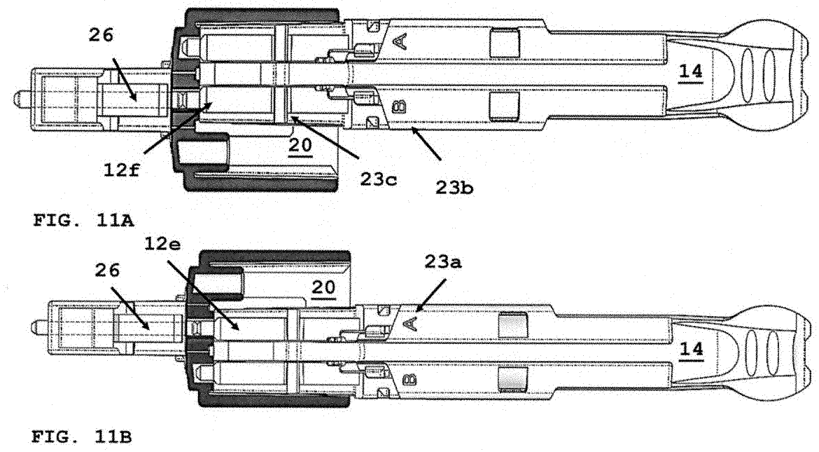

FIG. 9 depicts an exploded view of connector (14) being inserted into converter (20) with anchor device used to secure the connector via its recess (12a) within the second end port. In this embodiment, a simplex, female adapter (28) is secured to the male, LC-type optical connector (24). FIG. 10 depicts a top view of connector (14) secured within converter (20) at the second end (22) in signal test position “B” (23b). Active port (23c) is the middle port in which second ferrule (12(f)) or testing position “B” signal strength is being measured. FIG. 11A depicts connector (14) installed in test position “B” (23b), as depicted in FIG. 10. FIG. 11A is section along the top view further illustrating second ferrule (12f) is in optical communication with extended ferrule (26). FIG. 11B depicts connector (14) reinserted at the second end of the converter and configured to measure signal strength at first ferrule (12e) in optical communication with extended ferrule (26), in test position “A” (23a).

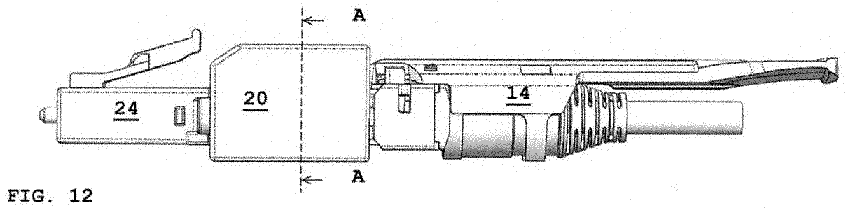

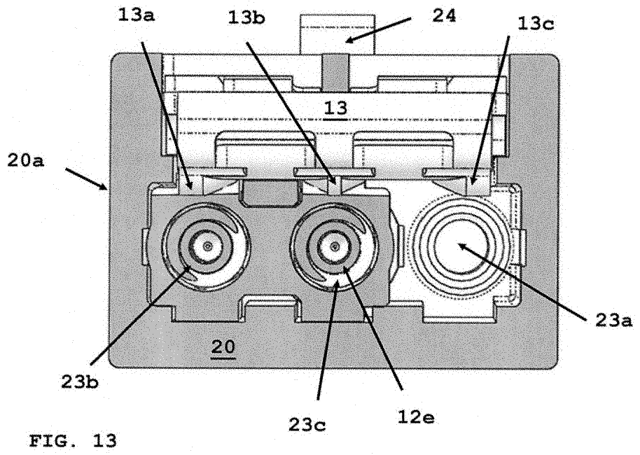

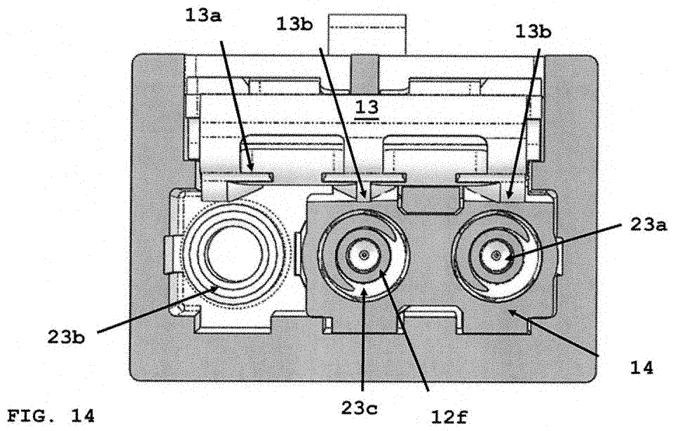

FIG. 12 depicts optical fiber connector (14) secured within converter (20). FIG. 13 depicts a cross-section view along line A-A of FIG. 12, connector (14) is secured in test position “B” (23b) with measured ferrule (12e) secured within active port (23c). Connector (14) is secured by anchor latches (13a, 13b) during testing. FIG. 14 depicts test position “A” (23a) with optical ferrule (12f) secured within signal test port (23c).

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A converter, comprising:
an outer housing having a first end and a second end forming a longitudinal channel therebetween;
the first end further comprises a port with an extended ferrule and at least one optical fiber within the extended optical ferrule;
the second end is configured to secure an optical fiber connector; and wherein
the extended optical ferrule is in optical communication with a first optical ferrule of the optical fiber connector for testing in test position “A” or in optical communication with a second optical ferrule of the optical fiber connector for testing in a test position “B”.

2. The converter according to claim 1, wherein either the test position “A” or the test position “B”, an optical signal strength transmitted using the optical fiber connector is determined in decibels.

3. The converter according to claim 2, wherein a first optical fiber connector is rotated one-hundred and eighty degrees (180) to change from the first test position “A” to the second test position “B” or to change from the second test position “B” to the first test position “A”.

4. The converter according to claim 2, wherein an adapter hook is inserted into the second end of the converter to accept and secure the optical fiber connector within a port at the second end formed by the adapter hook.

5. The converter according to claim 4, wherein the first optical fiber connector or the second optical fiber connector further comprises an outer housing with a recess, backbody, and ferrule assembly, and further wherein the recess is secured within the second end of the converter by the adapter hook.

6. The converter according to claim 5, wherein the adapter hook is an anchor device or opposing, vertically aligned hooks configured to secure the second optical fiber and the first optical fiber connector within the second end of the converter respectively.

7. The converter according to claim 6, wherein the second end has three ports, with two outer inactive port and a middle port is a signal test port.

8. The converter according to claim 7, wherein the combination of one inactive port and the signal test port forms test position “A” or the combination of the second inactive port and the signal test port forms test position “B”.

9. The converter according to claim 1, wherein the optical fiber connector is a third optical fiber connector with an external latch for securing the third optical fiber connector within the second end of the converter when the external latch is accepted within an opening formed as part of the outer housing of the converter.

10. The converter according to claim 1, wherein the first end is configured with a simplex male fiber optic connector with the extended ferrule.

11. The converter according to claim 9, wherein the extended optical ferrule further comprises an angled cut ferrule endface or a uniform polished endface with no angled cut.

12. The converter according to claim 9, wherein a simplex female adapter is secured to the male simplex connector to interconnect the converter with another part of a network.

13. A converter resulting in the configuration of claim 1.

14. A method of testing a optical fiber connector, comprising the steps of:
providing a converter of claim 13;
providing a tester with a simplex fiber optic connector port;
inserting the optical fiber connector in test position “A” of a second end of the converter; and
inserting the first end of the converter into the tester simplex fiber optic connector port.

15. The method of testing a optical fiber connector according to claim 14, including the step of rotating the optical fiber connector one-hundred and eighty (180) degrees to test position “B”.

16. The method of testing a second optical fiber connector according to claim 14, including the step of removing the second optical fiber connector from a first port representing test position “A” and inserting into a second port representing test position “B”.
